(19) United States
(12) Patent Application Publication
(10) Pub. No.: US 2004/0153991 A1
(43) Pub. Date: Aug. 5, 2004

(54) Method of realizing component object creation in over-address space based on dynamic kernel

(76) Inventors: Rong Chen, Shanghai (CN); Yongwen Du, Shanghai (CN); Qinghong Lin, Shanghai (CN)

Correspondence Address: RABIN & BERDO, P.C., Suite 500, 1101 14th Street, N.W., Washington, DC, 20005, US

(21) Appl. No.: 10/747,233

(22) Filed: Dec. 30, 2003

(30) Foreign Application Priority Data
Dec. 31, 2002 (CN) 02160134.8

(51) Int. Cl. G06F 9/44

(52) U.S. Cl. 717/100

(57) ABSTRACT

A flexible kernel realization method in computer operation system component-wise, in which the system function of computer operation system is abstracted as a object and is packaged into a independent component model with component technology, the system function interface is embodied in form of component object interface, and the model operation state is setup dynamically according to requirement. The component model is setup in kernel state operation or user state operation. The kernel state component model includes a logic abstract layer-component operation platform, the middleware component for component object creating in over-address space is generated with this operation platform. The flexible kernel technology in present invention combines the component technology into system kernel, the component technology is supported from system stage, so the operation states of application component in user space or kernel space could be flexible setup dynamically.

### FIELD OF THE INVENTION

The present invention relates to a realizing mechanism of dynamic kernel in computer operation system, especially relates to a method of realizing component object creation in over-address space based on dynamic kernel. The present invention belongs to the computer technology field.

### BACKGROUND OF THE INVENTION

The complexity of operation system is increased steadily with rapid development of computer hardware and user requirements and also Internet's coming out, the influences to system property by hierarchical structure of system are more and more obviously. Most operation systems utilize one of two hierarchical structures: i.e. monolithic kernel (monolithic kernel or macro-kernel) operation system, and micro kernel operation system.

Early operation system utilizes basically the monolithic kernel technology, the system service and drive program in this system are all in kernel space and defined into various function module respectively; each module could invoke other module according to specific interface specification; all the modules must connected with each other and forms a executable file, whole file should be uploaded completely into the internal storage of computer in utilization. The micro kernel functionally consists of the most basic abstract module in operation system, more system services and drive programs included in monolithic kernel system are outside of kernel, only the process managing, I/O handling, internal storage managing and inter-process communication etc are included within the kernel. The characteristics of monolithic kernel and micro kernel are respectively as below: monolithic kernel has high efficiency but poor stability, the micro kernel conversely has low efficiency but good stability. The reason for micro kernel's low efficiency is caused by the fact that more inter-process communications are utilized. Most system functions of monolithic kernel are realized in kernel and the system stability is lowered. Technically, it is not possible to resolve basically the contradiction between efficiency and stability i.e. the contradiction between micro kernel and monolithic kernel.

The component technology is applied widely in development of application software, applying the component technology in system software designation has become a research hot point, especially the development of distributed system provides a broad space for component technology.

### BRIEF DESCRIPTION OF THE INVENTON

The purpose of present invention is providing a method of realizing component object creation in over-address space based on dynamic kernel, in which the flexible kernel technology combines the component technology into system kernel, the component technology is supported from system stage, so the operation states of application component in user space or kernel space could be flexible setup dynamically.

Another purpose of present invention is providing a method of realizing component object creation in over-address space based on dynamic kernel, with it's system function interface component-wise, the component object is created through system component API and the component creation in over-address space is realized.

Another purpose of present invention is providing a method of realizing component object creation in over-address space based on dynamic kernel, on basis of user-middleware—three hierarchies structure service system, the component backup unit of kernel creates automatically a stub proxy component of component object which is as a middleware, and the component is accessed in over-process way by utilizing the stub proxy component of component object.

Another purpose of present invention is providing a method of realizing component object creation in over-address space based on dynamic kernel, in which the same component could operates directly within user space or kernel space in form of binary carrier.

So present invention realizes the above purposes through following technologies:

A flexible kernel realization method in computer operation system component-wise, in which the system function of computer operation system is abstracted as a object and is packaged into a independent component model with component technology, providing a system stage component technology backup, the system function interface is embodied in form of component object interface, and user could setup dynamically the model operation state in according to requirement and setup the component model in kernel state operation or user state operation. The user component may utilize the same method to obtain the interface of system function component object in kernel state and user state and the invoke methods are same.

Concretely, the kernel state component model includes internal storage manage, process/line manage and device manager. If needed, it may include further the extension component which sets up the relative fixed corresponding application component for concrete device or application, and file system component or graphic system component or network service component or device drive program component.

The user state component model includes extension component or file system component or graphic system component or network service component or device drive program component.

For invoking the component in over-address space through the middleware component by user, the kernel state component module includes logic abstract layer-component operation platform, the middleware component is generated for component object in over-address space with this operation platform. The middleware are proxy component object and stub component object; in which the stub component object is set in terminal of component object to be called; the proxy component object is set in creater terminal of object.

In the component object creation method based on said system function kernel component-wise in present invention, with the API provided to user from system, user could select creating component object in kernel space or in user space.

The system function interface is utilized in kernel space and the system function interface is invoked directly; the system function interface is invoked in user space and passed to real object via middleware, in time obtaining a certain system function interface from user space, the system would create automatically a proxy component/stub component corresponding to the interface and return the interface of proxy object back to user.

Further, the steps for creating user state component object in user space are as bellow:

Step 1: invoke creation function in user space, set up parameters among them and create component object in same address space;

Step 2: create the generic group of component in user space and create component object with the generic group;

Step 3; return the interface of component object and access directly the component object with the interface.

The steps for creating kernel state component object in user space are as bellow:

Step 1: invoke creation function in user space, set up parameters among them, indicate creating component object in kernel address space;

Step 2: trapping in the kernel with function of component operation backup unit in kernel, create the generic group of component in kernel, create component object with the generic group, generate stub object of component object and return to user state;

Step 3: return back to user space, in case of system finds out that the system function invokes returning an interface of remote object, it creates a proxy object corresponding to stub object;

Step 4: realize the access to real component object by utilizing proxy object interface through the inter-progress communication.

Of course, user could create component object in over-address space. In creating component object in over-address space way, the stub component/proxy component of middleware is created automatically by system, and the creation is realized by automatic marshaling.

Concretely, in course of component invoking in over-address space, the proxy object is responsible for the inter-progress communication and generates local proxy of remote object; a stub object is generated in the invoked component object' address space and is matched with proxy object, the invoke result is returned back to proxy object via stub object. In time of stub component object creating, obtain the metadata of relative interface of corresponding component object, and structure the interface form of stub according to metadata, i.e. create the fictitious table of stub, meanwhile the stub keeps information of pointer pointing to real object and interface address; in time of proxy component object creating, obtain fist also the metadata of relative interface of corresponding component object and structure the interface form of proxy according to metadata and keep information of interface address etc.

So both stub and proxy keep also a mark generated in system dynamically, the system matches a pair of proxy and stub by the mark. proxy/stub is corresponding to interface, in case of a component object which has more interfaces is remotely invoked, system creates a pair of proxy/stub object for each interface.

After setting up the channel of over-address space, the operation steps of proxy and stub are as bellow:

Step 1: after proxy creating, return back a intellectual pointer pointing to proxy object, and the invoking to intellectual pointer method is hence changed over to the invoking to proxy object method;

Step 2: proxy object invoking is skipped to kernel space through IPC;

Step 3: the system starts another a line in kernel space, utilizes the stack duplicated in IPC course in the line to invoke the stub object;

Step 4: invoke the real object from stub object, the real component object returns back to the stub invoking after being invoked.

Step 5: return to IPC from stub invoking, in IPC, duplicate the returned value and returned parameter into the space where proxy object existing according to the metadata of interface method;

Step 6: IPC returns back to proxy invoking;

Step 7: the proxy invoking is returned back to invoker.

The Step 2 above is included in IPC course, the metadata of corresponding interface is obtained through the interface address in proxy object, and the stack of proxy invoking is copied into kernel space according to metadata.

In operation system of present invention, part of system functions are packaged into independent component module with component technology, e.g. file system and graphic system. User could setup dynamically these operation states according to requirements, i.e. setup these component modules which have a reliable source or required a high operation efficiency into the kernel state, and setup those non-stable modules into user state operation according to user requirements, and in this way, the special requirements of stability, safety and real time could be met simultaneously within a system. It is no need to distinguish whether this hierarchy structure is a monolithic kernel or micro kernel, in fact the so called “kernel” may be big or small and is decided dynamically exactly according to the requirements of system itself. It is this creative “flexible kernel” hierarchy structure in present invention that resolves by component technology the contradiction of non-satisfying both sides of property and efficiency in monolithic kernel and micro kernel, with which the designers of operation system hierarchy structure are persecuted for long period.

### BRIEF DESCRIPTION OF THE APPENDED DRAWINGS

FIG. 1 is an illustrative view showing the 3 layers hierarchy structure in the operation system of present invention, in FIG. 1, 1 means dynamic link library function invoking; 2 means component object interfacing method invoking.

FIG. 2 is an illustrative view showing mapping mechanism of component operation platform sharing code dynamic link library in present invention.

FIG. 3 is a structure illustrative view showing creating component object interface in user space based on component-wise kernel in present invention.

FIG. 4 is a structure illustrative view showing creating component object interface in kernel space based on component operation platform sharing code dynamic link library in present invention.

FIG. 5 is a structure illustrative view showing creating component object interface in user space based on component operation platform sharing code dynamic link library in present invention.

FIG. 6 is an illustrative view showing proxy and stub generating in present invention.

FIG. 7 is a flowchart showing proxy and stub operation steps in times of creating component object in over-address space in present invention.

FIG. 8 is a realization flowchart of kernel mechanism in present invention.

FIG. 9 is s flowchart showing component interfacing method invoking in present invention.

### DETAILED DESCRIPTION OF THE INVENTION

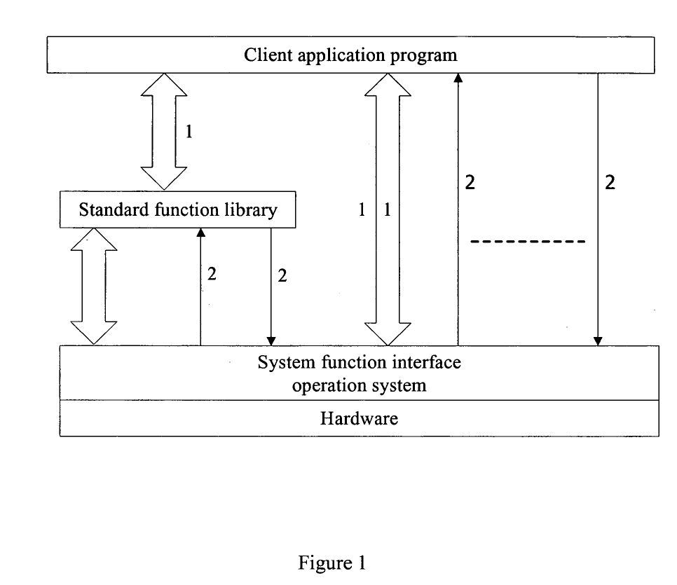

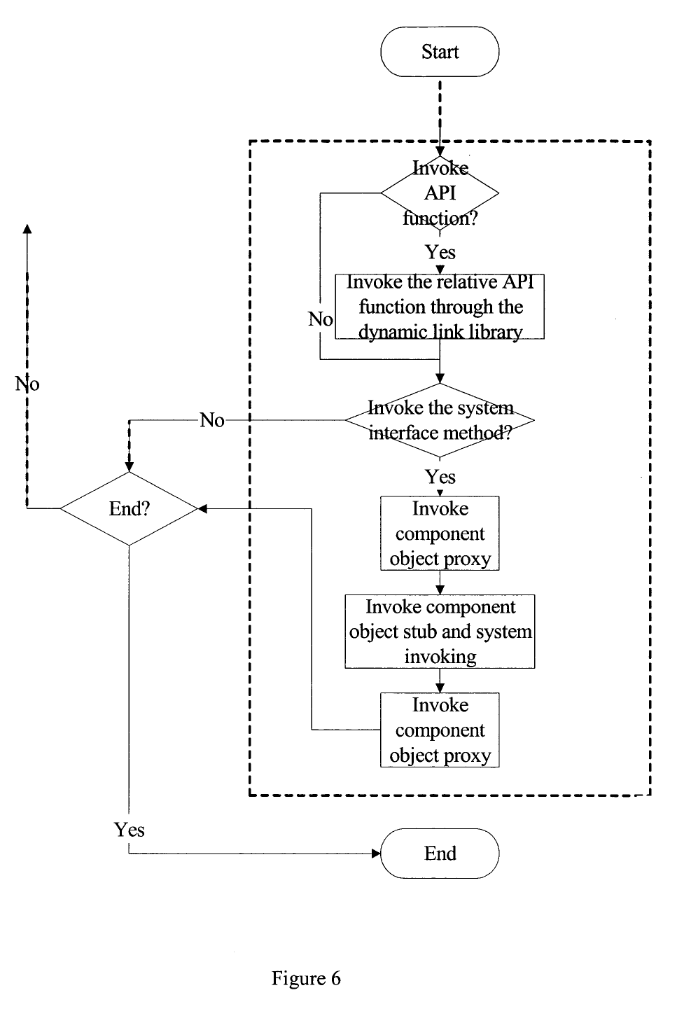

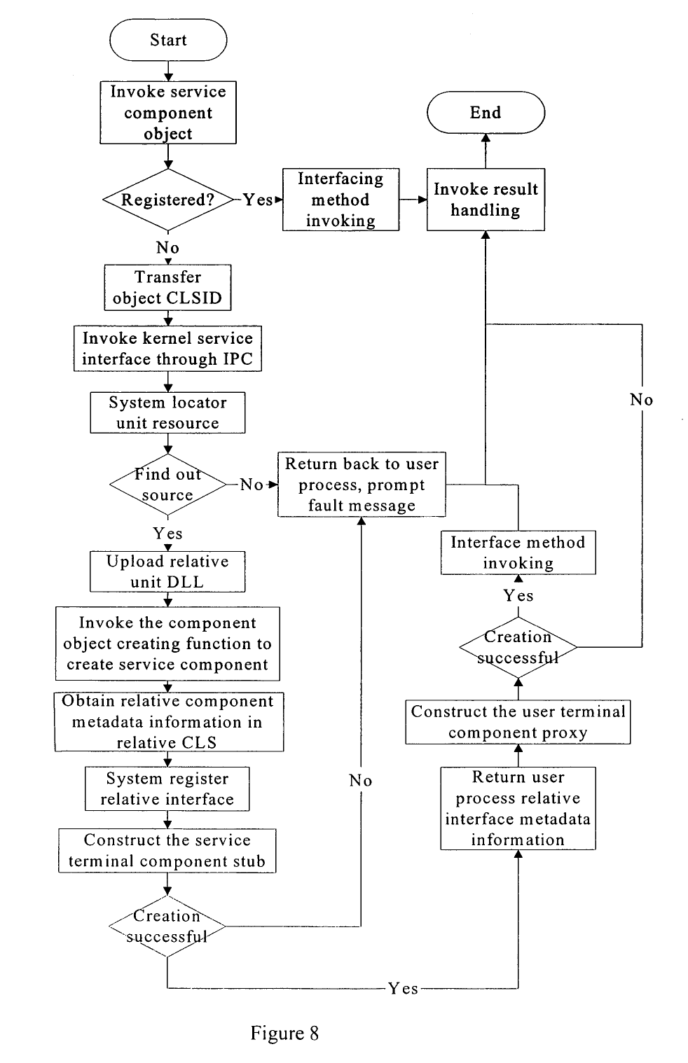

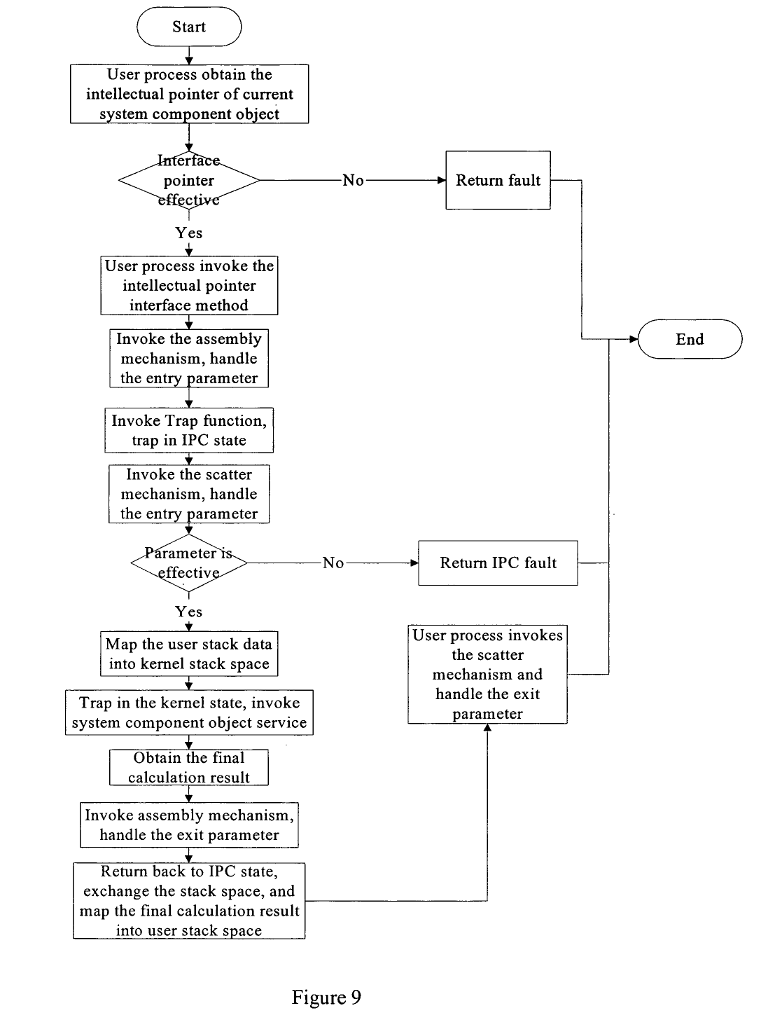

As show by FIGS. 1-9, the essential of present invention is introducing the component technology into kernel, so the kernel is in component-wise way with purpose of realizing a flexible system. With component-wise kernel, the system function of computer operation system is abstracted as a object and is packaged into a independent component model with component technology, providing a system stage component technology backup. A “3 layers structure” (Client/Middleware/Server) computing model is realized on the system layer by component technology advantage in present invention operation system, the application of component technology is combined totally into system kernel, by component and middleware technology, the component operation environment could be transparent to user and component maker, e.g. the component may be applied to various address space without revising.

The kernel state component module includes process component object, line component object, synchronism (Mutex, Monitor etc) component object, fictitious storage component object and device manager of control device. If needed it may include further the extension component which sets up the relative fixed corresponding application component for concrete device or application, the file system component or graphic system component or network service component or device drive program component; the user state component model includes extension component or file system component or graphic system component or network service component or device drive program component.

The user component could obtain the interface of system function component object by same method in kernel state and user state, and the invoking methods are same.

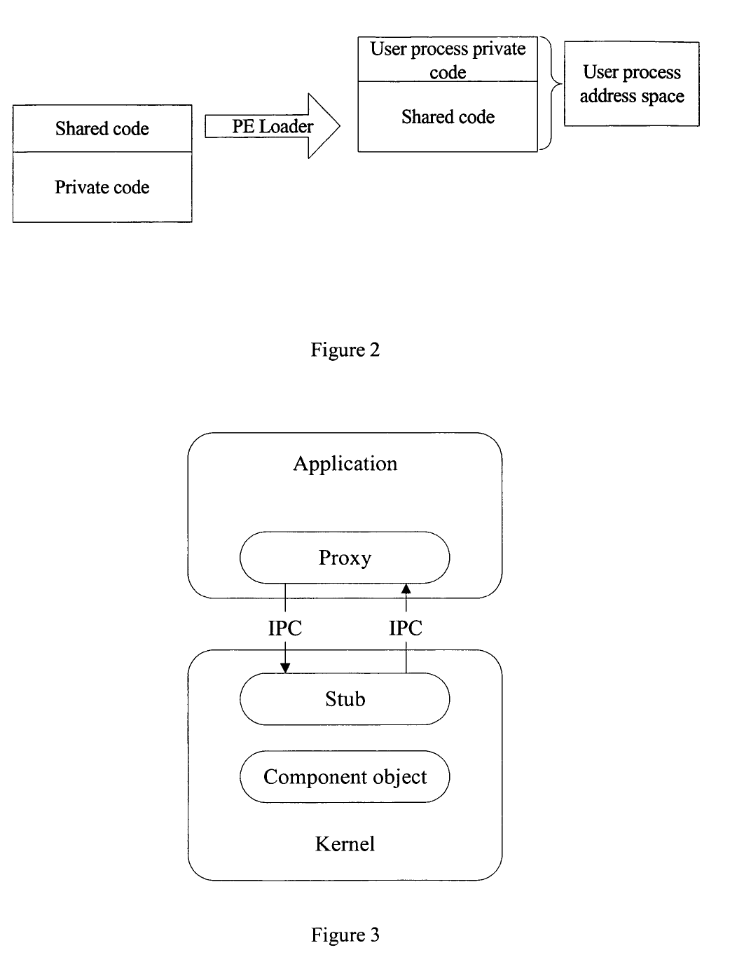

Refer to FIG. 2,4,5, in present invention, the component operation platform acting as a middleware is connected tightly with bottom layer operation system, in some extent, the component operation platform is a abstract layer of bottom layer operation system, the component operation platform is the interactive interface between client program and operation system, provides client program with the relative function invoking and component service and implies the characteristic of bottom layer operation system at same time. The component operation platform generates fictitious dynamic link library for kernel sharing code, by the mapping mechanism of the kernel sharing code, user program shares directly these codes, in course of uploading of user process, operate the binary carrier directly by registering this fictitious dynamic link library in user space. Meanwhile the component operation platform includes also the application function API, the API means the system invoking function provided by dynamic link library, e.g. process handling, line manage, class object etc, it supplies the basic component library service and/or backup function for user, the share codes in share code table are corresponding respectively with API.

In operation system of present invention, both the kernel code and user code are uploaded into the share address space (the private code of kernel is protected and the direct user process access is prohibited), compiler generates fictitious dynamic link library for kernel sharing code, by the mapping mechanism of the kernel sharing code, all the user programs share these codes, in initializing of uploading of user process, the operation system registers directly this fictitious dynamic link library in user space. The citing API table of dynamic link library is corresponding respectively to the kernel share code API table. The citing API of dynamic link library is basic component library service and other backup function provided to user.

The kernel code mapping in present invention is realized by dynamic link library mechanism, because they all in share address space, so the user process don't need to trap in the kernel space, this part code resource could be shared with only a long skip pointer, in this way, the system consumption of CPU state switchover may be reduced, and this part of codes are shared by all the process (the kernel is also a process), so the size of user object code may be reduced to the largest extent and this meets the application requirements in embed market. The standard function library is realized based on totally the system function interface.

Concretely, as FIG. 3,6 show, in system function interface utilization, the system function interface utilization in kernel space is a direct interface invoking; the system function interface invoking in user space pass to the real object by proxy/stub, in time obtaining a certain system function interface from user space, the system would create automatically a proxy/stub corresponding to the interface and return the interface of proxy object back to user.

Take a file system as an example. The concrete flows of uploading a component in kernel state and user state are as below:

1. Compile a component A first;

2. Programming a user program, create the object of component A in user state and invoke the method of it;

3. Programming a user program, create the object of component A in kernel state and invoke the method of it;

The operation results are identical.

In present invention, a over-address space is needed in case of utilizing the system function interface in user state, but over-address space don't be needed in case of utilizing the system function interface in kernel, the different of which is overlaid at all by works done by system.

System function interface obtaining flows in user state and kernel state are as below.

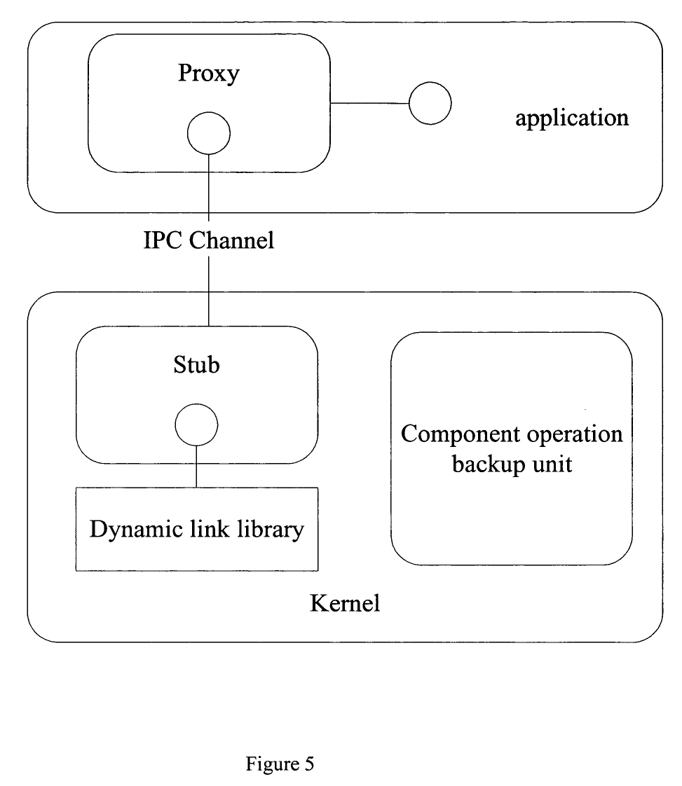

Take process creating as an example, refer to FIG. 5,8, system function interface obtaining flows in user state are as below.

1. Invoke the relative API function;

2 API function invokes the system function interface, trapping in the kernel state to create a new process by the inter-process communication (IPC), and create a stub object corresponding to the new process component object interface;

3. IPC returns back to user space, in case of system finds out that the system function invokes returning a interface of remote object, it creates a proxy (proxy) object corresponding to stub (stub) object;

4. Realize the access to real component object by utilizing the obtained proxy object interface through the inter-progress communication.

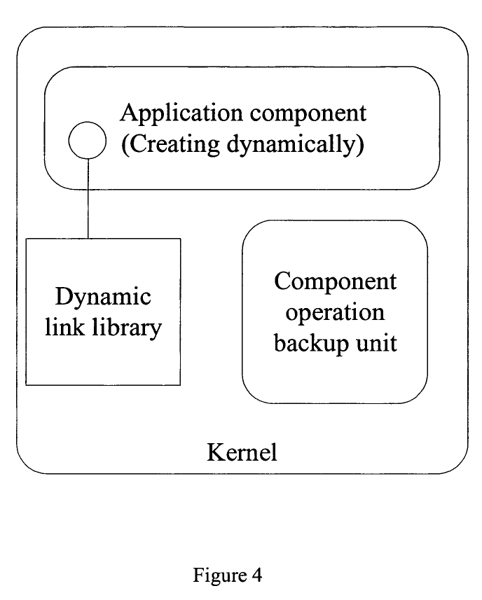

Take process creating as an example, refer to FIG. 4, system function interface obtaining flows in kernel state are as below.

1. Invoke the relative API function;

2 API function invokes the system function interface, owing to it is already in kernel, so create a new process directly;

3. Return back to the interface of new process directly;

4. Invoke directly the interface of process object.

For component object creation, the invoking of system function interface in present invention has no relation to the user operation state, so the component of system function interface based on present invention may be created and utilized in various operation state, i.e. same binary codes may be operated in kernel state and user state without any changing and the interface utilization may not be influenced by operation space.

It may even to say that the component operated in kernel state looks like a extensive system function, however the difference with system function interface is that: the system function interface is a necessary component for system operation, but user component may be uploaded or not; moreover the system component object behind the system function interface is created in accordance with the requirement for system, and user may not involve in the creation of system component object, but the user component has a creating course of comparing & displaying.

Whether creating the user component in user state or kernel state, it is transparent to user, it looks to user that he or she always interacts with real object. The operation system in present invention takes kernel as a process, it could be selected whether creating component object in user space or in kernel space with the API provided by present invention.

The flow for creating kernel state component object in user space is as bellow:

1. invoke creation function in user space, set up parameters among them, indicate creating component object in kernel address space;

2. trapping in the kernel with function of component operation backup unit in kernel, create the generic group of component in kernel, create component object with the generic group, generate stub object of component object and return to user state;

3. return back to user space, in case of system finds out that the system function invokes returning an interface of remote object, it creates a proxy (proxy) object corresponding to stub (stub) object;

4. realize the access to real component object by utilizing proxy object interface through the inter-progress communication.

The flow for creating component object in user space is as bellow:

1. invoke creation function in user space, set up parameters among them and create component object in same address space;

2. the creating function creates the generic group of component in user space and create component object with the generic group;

3. return the interface of component object and access directly the component object with the interface.

The component operation environment in present invention is a external expression of utilization of flexible kernel technology. The basis of realizing flexible kernel technology in present invention is combining the component technology into kernel, the system could create stub proxy object automatically for over-address space interface and realize an automatic marshalling.

In invoking of over-address space, the transfer problem of invoking parameter and returning value should be considered, the assembly means collecting the parameters of method into packet and preparing to transfer to another address space; the scatter means open the received data packet at another terminal, the scatter and assembly are called marshalling together. In process of marshalling, the data format has to be handled, including data size and data arrangement. These information for describing data may be called metadata, the metadata in present invention means exactly the data which is used for describing the component information, including component function and interface form. There are two methods for obtaining metadata. One is register these information statically into system to be inquired & obtained in necessary. Other is package the metadata directly into component, in which the system cost may be cut down.

Concretely, the creation of stub proxy component in present invention is in component invoking of over-address space, because invoker party and invoked party are not in same address space, so direct invoking couldn't be realized, the proxy object is a local proxy of remote object generated for inter-process communication just for this reason. Corresponding to this, a stub object is generated also in the invoked component object' address space and matched with proxy object, the invoke result is returned back to proxy object via stub object. When more address spaces invoke a component at same time, the invoked component object would generates a stub component for each address (corresponding to the proxy component object generated in process invoking); in time of stub component object creating, obtain the metadata of relative interface of corresponding component object first, and structure the interface form of stub according to metadata. i.e. create the fictitious table of stub, meanwhile the stub keeps information of pointer pointing to real object and interface address.

In time of proxy component object creating, obtain fist also the metadata of relative interface of corresponding component object, and structure the interface form of proxy according to metadata. Keep information of interface address etc.

Both stub and proxy keep also a mark generated by system dynamically, the system matches a pair of proxy and stub by the mark.

It should be emphasized that proxy/stub is corresponding to interface, in case of a component object which has more interfaces is remotely invoked, system creates a pair of proxy/stub object for each interface.

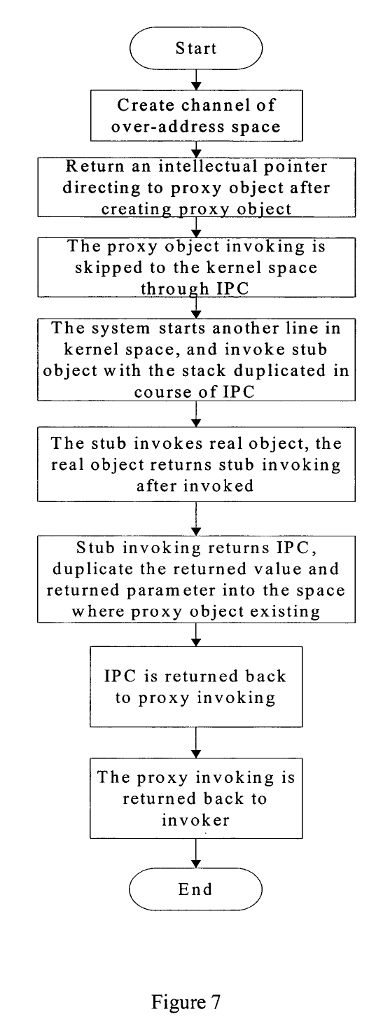

Refer to FIG. 7, for stub proxy operation, the following operation be executed after creation of over-address channel in the present invention:

Step 1: After proxy creation, return back a intellectual pointer pointing to proxy object, and the invoking to intellectual pointer method is hence changed over to the invoking to proxy object method;

Step 2: proxy object invoking is skipped to kernel space through IPC. In IPC course, the metadata of corresponding interface is obtained with interface address in proxy object and the stack of proxy invoking is copied into kernel space according to metadata;

Step 3: The system starts another a line in kernel space, utilize the stack duplicated in IPC course in the line to invoke the stub object;

Step 4: invoke the real component object from stub object, the real component object returns back to stub invoking after invoked;

Step 5: the stub invoking return to IPC, in IPC, duplicate the returned value and returned parameter into the space where proxy object existing according to the metadata of interfacing method;

Step 6: IPC returns back to proxy invoking;

Step 7: The proxy invoking is returned back to invoker.

While the present invention has been particularly shown and described with references to preferred embodiments thereof, it is clearly understood that the same is by way of illustration and example only and is not to be taken by way of limitation, it will be understood by those skilled in the art that various variations, alterations, and modifications in form and details may be made therein without departing from the spirit and scope of the invention as defined by the claims and it intended to be encompassed in the scope of the present invention.

We claim:

1. A flexible kernel realization method in computer operation system component-wise, characterized in that: the system function of computer operation system is abstracted as a object and is packaged into a independent component model with component technology, providing a system stage component technology backup, the system function interface is embodied in form of component object interface, and user could setup dynamically the model operation state in according to requirement and setup the component model in kernel state operation or user state operation.

2. A flexible kernel realization method in computer operation system component-wise according to claim 1, characterized in that: the user component may utilize the same method to obtain the interface of system function component object in kernel state and user state and the invoke methods are same.

3. A flexible kernel realization method in computer operation system component-wise according to claim 1, characterized in that: the kernel state component model includes internal storage manage, process/line manage and device manager.

4. A flexible kernel realization method in computer operation system component-wise according to claim 3, characterized in that: the kernel state component model includes further the extension component which sets up the relative fixed corresponding application component for concrete device or application.

5. A flexible kernel realization method in computer operation system component-wise according to claim 4, characterized in that: the kernel state component model includes further file system component or graphic system component or network service component or device drive program component.

6. A flexible kernel realization method in computer operation system component-wise according to claim 1, characterized in that: the user state component model includes extension component or file system component or graphic system component or network service component or device drive program component.

7. A flexible kernel realization method in computer operation system component-wise according to claim 1, characterized in that: the kernel state component module includes logic abstract layer-component operation platform, the middleware component is generated for component object in over-address space with this operation platform, user invokes component of over-address space via the middleware component.

8. A flexible kernel realization method in computer operation system component-wise according to claim 7, characterized in that: the middleware are proxy component object and stub component object; in which the stub component object is set in terminal of component object to be called; the proxy component object is set in caller terminal of object.

9. A flexible kernel realization method in computer operation system component-wise according to claim 8, characterized in that: when more address spaces invoke a component at same time, the invoked component generates a stub component object for each address spaces invoker, the component is corresponding to the proxy component object on invoker terminal.

10. A flexible kernel realization method in computer operation system component-wise according to claim 8, characterized in that: the component operation platform includes further application function API, the API provides user with basic component library service and/or backup function, the shared codes are corresponding to each API respectively.

11. A component object creation method based on said system function kernel component-wise, characterized in that: with the API provided to user from system, user could select creating component object in kernel space or in user space.

12. A component object creation method based on said system function kernel component-wise according to claim 11, characterized in that: the system function interface is utilized in kernel space and the system function interface is invoked directly.

13. A component object creation method based on said system function kernel component-wise according to claim 11, characterized in that: the system function interface is invoked in user space and passed to real object via middleware, in time obtaining a certain system function interface from user space, the system would create automatically a proxy component/stub component corresponding to the interface and return the interface of proxy object back to user.

14. A component object creation method based on said system function kernel component-wise according to claim 11, characterized in that: the steps for creating user state component object in user space are as bellow:
Step 1: invoke creation function in user space, set up parameters among them and create component object in same address space;
Step 2: create the generic group of component in user space and create component object with the generic group;
Step 3; return the interface of component object and access directly the component object with the interface.

15. A component object creation method based on said system function kernel component-wise according to claim 11, characterized in that: the steps for creating kernel state component object in user space are as bellow:
Step 1: invoke creation function in user space, set up parameters among them, indicate creating component object in kernel address space;
Step 2: trapping in the kernel with function of component operation backup unit in kernel, create the generic group of component in kernel, create component object with the generic group, generate stub object of component object and return to user state;
Step 3: return back to user space, in case of system finds out that the system function invokes returning an interface of remote object, it creates a proxy object corresponding to stub object;
Step 4: realize the access to real component object by utilizing proxy object interface through the inter-progress communication.

16. A component object creation method based on said system function kernel component-wise according to claim 11, characterized in that: user could create component object in over-address space, in creating component object in over-address space way, the stub component/proxy component of middleware is created automatically by system, and the creation is realized by automatic marshaling.

17. A component object creation method based on said system function kernel component-wise according to claim 16, characterized in that: in course of component invoking in over-address space, the proxy object is responsible for the inter-progress communication and generates local proxy of remote object; a stub object is generated in the invoked component object' address space and is matched with proxy object, the invoke result is returned back to proxy object via stub object.

18. A component object creation method based on said system function kernel component-wise according to claim 17, characterized in that: in time of stub component object creating, obtain the metadata of relative interface of corresponding component object, and structure the interface form of stub according to metadata, i.e. create the fictitious table of stub, meanwhile the stub keeps information of pointer pointing to real object and interface address.

19. A component object creation method based on said system function kernel component-wise according to claim 17, characterized in that: in time of proxy component object creating, obtain fist also the metadata of relative interface of corresponding component object and structure the interface form of proxy according to metadata and keep information of interface address etc.

20. A component object creation method based on said system function kernel component-wise according to claim 17, characterized in that: both stub and proxy keep also a mark generated in system dynamically, the system matches a pair of proxy and stub by the mark.

21. A component object creation method based on said system function kernel component-wise according to claim 17, characterized in that: proxy/stub is corresponding to interface, in case of a component object which has more interfaces is remotely invoked, system creates a pair of proxy/stub object for each interface.

22. A component object creation method based on said system function kernel component-wise according to claim 21, characterized in that: after setting up the channel of over-address space, the operation steps of proxy and stub are as bellow:
Step 1: after proxy creating, return back a intellectual pointer pointing to proxy object, and the invoking to intellectual pointer method is hence changed over to the invoking to proxy object method;
Step 2: proxy object invoking is skipped to kernel space through IPC;
Step 3: the system starts another a line in kernel space, utilizes the stack duplicated in IPC course in the line to invoke the stub object;
Step 4: invoke the real component object from stub object, the real component object returns back to the stub invoking after being invoked;
Step 5: return to IPC from stub invoking, in IPC, duplicate the returned value and returned parameter into the space where proxy object existing according to the metadata of interface method;
Step 6: IPC returns back to proxy invoking;
Step 7: the proxy invoking is returned back to invoker.

23. A over-address space component object creation method based on said system kernel function component-wise according to claim 22, characterized in that: the Step 2 is included in IPC course, the metadata of corresponding interface is obtained through the interface address in proxy object, and the stack of proxy invoking is copied into kernel space according to metadata.
